(19) United States
(12) Patent Application Publication
(10) Pub. No.: US 2026/0358783 A1
(43) Pub. Date: Nov. 12, 2026

(54) Method and Manufacturing Installation for Producing a Workpiece

(71) Applicant: Carl Zeiss Digital Innovation GmbH, Dresden (DE)

(72) Inventor: Daniel Goersch, Oberkochen (DE)

(21) Appl. No.: 19/714,187

(22) Filed: Jun. 19, 2026

Related U.S. Application Data
(63) Continuation of application No. PCT/EP2023/086557, filed on Dec. 19, 2023.

(51) Int. Cl. G05B 19/401; G05B 19/4097; G05B 19/4155

(52) U.S. Cl. CPC G05B 19/401; G05B 19/4097; G05B 19/4155

(57) ABSTRACT

A method for producing a workpiece uses a manufacturing installation having a manufacturing machine, a movable machine element, a controller, and a metrology device. The method obtains nominal workpiece data, a control program with control commands and nominal numerical control parameters, and a data set linking past numerical control parameters to past measurement values for workpieces from past production runs in a first temporal sequence. The method also obtains data pairs for recent production runs, each including actual numerical control parameters and resulting actual measurement values. A reference sequence of data pairs is defined from the nominal numerical control parameters and nominal measurement values corresponding to the nominal workpiece data. Modified numerical control parameters are determined using the reference sequence, the past data set, and the recent data pairs as a starting sequence. The workpiece is produced using the control program with the modified numerical control parameters.

### CROSS-REFERENCE TO RELATED APPLICATIONS

This application is a continuation of PCT Application No. PCT/EP2023/086557 filed Dec. 19, 2023, the entire disclosure of which is incorporated by reference.

### FIELD

The present disclosure relates to a method for producing a workpiece using a manufacturing installation that comprises a manufacturing machine having a moveable machine element and comprises a machine controller configured to control the moveable machine element based on a control program. The invention further relates to a manufacturing installation for producing a workpiece using the method, and to a computer program that facilitates implementation of such a method in a manufacturing installation.

### BACKGROUND

In many branches of industry, intense efforts are made to increase production output and product quality. Production quality is often defined in terms of whether the produced workpieces comply with predefined workpiece specifications. Workpieces not complying with the predefined specifications either require re-working or will be discarded, both of which reduces production output and efficiency. In order to monitor production quality, it has become known to integrate one or more metrology devices into the manufacturing installation and sometimes even directly into the manufacturing machine. However, it is difficult to adjust a manufacturing process in real time if product quality decreases during a plurality of production runs, because recording and evaluation of measurement results on workpieces during production or shortly after production requires time and causes delay. The time delay may often be too long to be effectively used for closed-loop manufacturing control. Time-to-result in measurement processes is often significantly longer than production cycle times or period lengths of production process fluctuations.

Notwithstanding, quality control has been of utmost interest in industrial manufacturing processes for years in order to achieve both cost-effective production and high product acceptance on the customer's side. There are many concepts and approaches for establishing quality control processes in the industrial manufacture of workpieces.

By way of example, U.S. Pat. No. 11,249,458 B2 discloses a control system including a controller that controls machining of a workpiece, and including a photographing device that photographs an image of the workpiece under machining operation. The controller generates a three-dimensional model of the workpiece under machining operation based on the acquired image, compares the generated three-dimensional model and a three-dimensional model generated by a machining simulation with each other, and determines a presence or absence of a machining defect based on a result of the comparison. When the machining defect is present and re-machining is possible, a setting is modified depending on a cause of the machining defect and additional machining is executed based on the modified setting.

U.S. Pat. No. 11,049,236 B2 discloses a system and method for performing real-time quality inspection of objects. The system and method include a transport to move objects being inspected, allowing the inspection to be performed in-line. At least one optical acquisition unit captures optical images of the objects being inspected. The optical images are matched to CAD models of objects, and the matched CAD model is extracted. A laser with an illumination light beam has a wavelength in the violet or ultraviolet range and conducts scans of the objects, which are formed into three-dimensional point clouds. The point clouds are compared to the extracted CAD models for each object, and the object is determined to be acceptable or defective based on the extent of deviation between the point cloud and the CAD model.

US 2021/0208568 A discloses a manufacturing system comprising: a communication module for receiving a three-dimensional model and control commands including manufacturing instructions for the manufacturing machine with respective reference values, tolerance values, and/or intervention tolerance values; a manufacturing module, wherein the model, the instructions, and the commands are used to manufacture an object; a calculating module using the three-dimensional model and the manufacturing instructions to calculate the control commands; and a measuring device having a communication module for receiving the three-dimensional model, a capture module using sensors to measure the manufactured object, captured for the reference values and/or the tolerance values and/or intervention tolerance values, and a checking module, wherein a divergence of the measured values from the applicable manufacturing reference values and an exceeding of the associated manufacturing tolerance values and/or the associated intervention tolerance values result in a control signal.

U.S. Pat. No. 9,383,742 B2 discloses a system and method for error compensation in positioning a complex-shaped gas turbine engine part during manufacturing thereof with a machine. Theoretical measurements for a plurality of control points on the part are first retrieved. Actual measurements for the control points are then acquired in a coordinate system of the machine. If an error between the actual and theoretical measurements is beyond a tolerance, a transformation matrix is computed. The transformation matrix represents a transformation to be applied to the coordinate system to adjust a pose thereof for compensating the error. The transformation matrix may be computed and applied to the coordinate system iteratively until the actual measurements are brought within tolerance. A machining program may then be generated for manufacturing the part accordingly.

EP 3 045 992 A1 discloses a method using a feedback loop for compensating errors occurring in a production process. The method comprises generating actual property data of at least one sample object produced in a production assembly according to a production model, performing a nominal-actual value comparison thereby generating deviation data, and automatically creating an adapted production model based on nominal property data and on the deviation data. The adapted production model is useable in an adapted production process for producing an adapted object in the production assembly, and differs from the nominal property data so that the errors occurring in the production process are at least partially compensated in the adapted production process.

U.S. Pat. No. 6,975,918 B2 discloses a production system for the series manufacture of products, comprising a processing device which, as a function of control commands, actuates a tool for processing one of the products, a measuring device for the automatic measuring of a geometric actual dimension at one of the processed products, a correcting device which is coupled to the processing device and to the measuring device and which compares the actual dimension with a preset target dimension which lies within a tolerance interval. The correcting device intervenes in a corrective manner in the control commands of the tool if the actual dimension lies outside an intervention interval which lies within the tolerance interval.

U.S. Pat. No. 11,036,203 B2 discloses a fabrication system for fabricating a three-dimensional object using processing circuitry. The processing circuitry estimates, according to a fabrication condition and fabrication data, a three-dimensional object to be fabricated according to the fabrication data and corrects the fabrication data according to an estimation result of the three-dimensional object estimated by the processing circuitry.

U.S. Pat. No. 8,090,557 B2 discloses a method for operating an industrial processing machine, a production machine or a manipulation robot. At least part of the operation of the industrial machine is simulated with the aid of a simulation model and the simulated results and real-time data from the operation of the industrial machine are stored. The simulation can be carried out in the industrial machine and if this is the case a parametric representation of the simulation model can be at least partly produced using a unit for this purpose. To produce the parametric representation, a data-systems connection can be created between the industrial machine and the unit, by means of an Intranet and/or an Internet connection. In addition, the simulation can be carried out in an external simulation unit, the latter having a data-systems connection to the industrial machine by means of an Intranet and/or an Internet connection.

WO 2018/204410 discloses a system comprising a first data link to a manufacturing system configured to create a run of parts based on a common engineering schematic, comprising a second data link to a metrology device configured to measure at least some parts in the run of parts to generate measurement data representing a physical shape of each part of the at least some parts, and comprising a machine learning system including one or more processors in communication with a computer-readable memory storing executable instructions, wherein the one or more processors are programmed by the executable instructions to at least: access a neural network trained, based on measurement data of past parts in the run of parts, to make a prediction about a future part in the run of parts; forward pass the measurement data through the neural network to generate the prediction about the future part in the run; and determine whether to output instructions for adjusting operations of the manufacturing system based on the prediction.

U.S. Pat. No. 10,180,667 B2 discloses a measurement technique integrated into a manufacturing machine in which the measurement results are interpreted by a trained artificial intelligence (AI). The AI determines new nominal control data based on the measurement results.

Some prior art approaches aim to make corrections even before a workpiece is actually produced. In other words, they try to implement some sort of forward or preemptive error correction using knowledge gained from a previously produced workpiece in the production process of a subsequently produced workpiece. Preemptive error correction appears very desirable for optimizing efficiency and output of a real, non-ideal manufacturing installation. Unfortunately, industrial manufacturing processes and installations can be very complex, and it is often difficult to clearly identify all the causes and effects that can lead to undesired production errors and product deficiencies. It is therefore common practice to operate a real manufacturing installation with process parameters that are carefully selected in such a manner that desired product characteristics are likely met even if the actual production run is affected in an unexpected manner. In other words, it is accepted best practice to not push a manufacturing installation to its limits if high product quality is a major goal.

Preemptive error correction becomes even more difficult if the number of workpieces to be produced, i.e. the batch size, is small. It is particularly difficult to estimate the causes and effects leading to production errors if only a small number of samples are available. On the other hand, it is more and more desirable to produce workpieces in small batch sizes (up to a batch size of a single piece) in order to enable customer specific variations.

In a more general field of endeavor, namely what is called systems theory, a behavioral approach is discussed. By way of example, a publication titled “Behavioral systems theory in data-driven analysis, signal processing, and control” by Ivan Markovsky and Florian Dörfler, published in Annual Reviews in Control, Vol. 52, 2021, explain such behavioral approach. In an example, an autonomous walking excavator based on the approach is described. In another publication titled “Bridging direct & indirect data-driven control formulations via regularizations and relaxations” by Florian Dörfler, Jeremy Coulson, and Ivan Markovsky, published in IEEE Transactions on Automatic Control, vol. 68, 2023, the authors discuss connections between sequential system identification and control for linear time-invariant systems, often termed indirect data-driven control, as well as a contemporary direct data-driven control approach seeking an optimal decision compatible with recorded data assembled in a Hankel matrix and robustified through suitable regularizations. Another publication titled “Data-driven model predictive control: closed-loop guarantees and experimental results” by Julian Berberich, Johannes Köhler, Matthias A. Müller, Frank Allgöwer, published in at-Automatisierungstechnik, vol. 69, 2021, provides a comprehensive review and describes a practical implementation of a model predictive control (MPC) framework using only measured data and no explicit model knowledge.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In view of the above, it is an object of the present invention to provide an improved manufacturing method and installation for efficiently producing workpieces with high product quality.

It is a further object to provide a method and installation that allow an efficient production of workpieces both in large and small batch sizes.

It is yet another object to provide a manufacturing method and installation that efficiently exploit knowledge gained during previous production runs in order to achieve high product quality.

According to a first aspect, there is provided a method for producing a workpiece using a manufacturing installation that comprises a manufacturing machine having a moveable machine element, a machine controller configured to control the moveable machine element based on a control program, and a metrology device configured to record a set of measurement values on the produced workpiece in order to determine workpiece characteristics of the produced workpiece, the method comprising the steps of
obtaining nominal workpiece data defining desired workpiece characteristics for the workpiece,
obtaining the control program, the control program comprising a plurality of control commands and a plurality of nominal numerical control parameters, with the nominal numerical control parameters each determining a nominal kinematic behavior of the moveable machine element during a production run,
obtaining a data set that comprises a plurality of past numerical control parameters used during a plurality of past production runs on the manufacturing machine and comprises a plurality of past measurement values recorded on workpieces produced by the plurality of past production runs, wherein the plurality of past numerical control parameters and the plurality of past measurement values are associated with each other based on the workpieces produced such that a first plurality of data pairs are formed, with each data pair of the first plurality of data pairs comprising past numerical control parameters and past measurement values resulting therefrom, and with the first plurality of data pairs representing a temporal sequence of the past production runs,
obtaining a second plurality of data pairs that represent a temporal sequence of recent production runs, with each data pair of the second plurality of data pairs comprising respective actual numerical control parameters used during a respective one of the recent production runs and respective actual measurement values resulting therefrom,
defining a reference sequence of data pairs based on the nominal numerical control parameters and based on nominal measurement values corresponding to the nominal workpiece data,
determining modified numerical control parameters using the reference sequence of data pairs, using the data set comprising the first plurality of data pairs, and using the second plurality of data pairs, wherein the second plurality of data pairs are used as a starting sequence, and wherein the modified numerical control parameters define at least one data pair that extends the starting sequence based on the first plurality of data pairs and based on the nominal measurement values from the reference sequence of data pairs, and
producing the workpiece using the moveable machine element, the machine controller and the control program in combination with the modified numerical control parameters instead of the nominal numerical control parameters.

According to another aspect, there is provided a manufacturing installation for producing a workpiece comprising a manufacturing machine having a moveable machine element, comprising a machine controller configured to control the moveable machine element based on a control program, and comprising a metrology device configured to record a set of measurement values on a produced workpiece in order to determine workpiece characteristics of the produced workpiece, wherein the machine controller comprises at least one processor configured to obtain nominal workpiece data defining desired workpiece characteristics for the workpiece, configured to obtain the control program, the control program comprising a plurality of control commands and a plurality of nominal numerical control parameters, with the nominal numerical control parameters each determining a nominal kinematic behavior of the moveable machine element during a production run, configured to obtain a data set that comprises a plurality of past numerical control parameters used during a plurality of past production runs on the manufacturing machine and comprises a plurality of past measurement values recorded on workpieces produced by the plurality of past production runs, wherein the plurality of past numerical control parameters and the plurality of past measurement values are associated to each other based on the workpieces produced such that a first plurality of data pairs are formed, with each data pair of the first plurality of data pairs comprising past numerical control parameters and past measurement values resulting therefrom, and with the first plurality of data pairs representing a temporal sequence of the past production runs, configured to obtain a second plurality of data pairs that represent a temporal sequence of recent production runs, with each data pair of the second plurality of data pairs comprising respective actual numerical control parameters used during a respective one of the recent production runs and respective actual measurement values resulting therefrom, configured to obtain a reference sequence of data pairs based on the nominal numerical control parameters and based on nominal measurement values corresponding to the nominal workpiece data, configured to determine modified numerical control parameters using the reference sequence of data pairs, using the data set comprising the first plurality of data pairs, and using the second plurality of data pairs as a defined starting sequence, wherein the modified numerical control parameters define at least one data pair that extends the defined starting sequence based on the first plurality of data pairs and based on the nominal measurement values from the reference sequence of data pairs, and configured to produce the workpiece using the moveable machine element, the machine controller and the control program in combination with the modified numerical control parameters instead of the nominal numerical control parameters.

There is also provided a computer program comprising program code configured to carry out the following method steps, when the program code is executed on at least one processor of a manufacturing installation that comprises a moveable machine element:
obtaining nominal workpiece data defining desired workpiece characteristics for the workpiece,
obtaining a control program comprising a plurality of control commands and a plurality of nominal numerical control parameters, with the nominal numerical control parameters each determining a nominal kinematic behavior of the moveable machine element during a production run,
obtaining a data set that comprises a plurality of past numerical control parameters used during a plurality of past production runs on the manufacturing machine and comprises a plurality of past measurement values recorded on workpieces produced by the plurality of past production runs, wherein the plurality of past numerical control parameters and the plurality of past measurement values are associated to each other based on the workpieces produced such that a first plurality of data pairs are formed, with each data pair of the first plurality of data pairs comprising past numerical control parameters and past measurement values resulting therefrom, and with the first plurality of data pairs representing a temporal sequence of the past production runs,
obtaining a second plurality of data pairs that represent a temporal sequence of recent production runs, with each data pair of the second plurality of data pairs comprising respective actual numerical control parameters used during a respective one of the recent production runs and respective actual measurement values resulting therefrom,
obtaining a reference sequence of data pairs based on the nominal numerical control parameters and based on nominal measurement values corresponding to the nominal workpiece data,
determining modified numerical control parameters using the reference sequence of data pairs, using the data set comprising the first plurality of data pairs, and using the second plurality of data pairs, wherein the second plurality of data pairs define a starting sequence, and wherein the modified numerical control parameters define at least one data pair that extends the starting sequence based on the first plurality of data pairs and based on the nominal measurement values from the reference sequence of data pairs, and
controlling the moveable machine element using the control program in combination with the modified numerical control parameters instead of the nominal numerical control parameters.

The new method and manufacturing installation thus exploit knowledge about the behavior of the manufacturing installation gained over a plurality of past production runs using the manufacturing machine and gained from measurement values recorded on workpieces produced by the plurality of these past production runs. Preferably, the past production runs are carried out on the very same manufacturing machine that is later used for producing the new workpiece, although it is generally conceivable to transfer knowledge gained with one specimen of a manufacturing machine to another specimen of the same type of manufacturing machine. In any case, a history of past production runs is advantageously used for controlling a new production run in a most efficient manner. The past production runs are production runs where the manufacturing machine including the moveable machine element were used for actually producing respective workpieces. Said workpieces were then measured and the control parameters used in the actual production runs and the measurement values resulting from said actual production runs are recorded and respectively assigned to form respective data pairs, each representing the system behavior during an actual past production run. In other words, the new method and manufacturing installation exploit knowledge about the actual behavior of the manufacturing installation gained over a history of past production runs and based on workpieces produced by these past production runs.

A first plurality of such data pairs is recorded in such a manner that each data pair represents an individual and real relationship between the numerical control parameters used during the defined workpiece production and the resulting workpiece characteristics. Accordingly, each data pair represents actual behavior of the manufacturing installation during an individual period of time. Moreover, the data set represents the development of the actual behavior over the time, i.e. a temporal development of the machine behavior. Advantageously, the data set may comprise the first plurality of data pairs arranged in a series of data pairs in such a manner that the series corresponds to the order of the past production runs. It is conceivable, however, that the data set comprises the first plurality of data pairs in a different order or arrangement, provided that the temporal development is still represented or can be retrieved, such as by exploiting appropriate meta data representing the order of the past production runs for instance. In other words, the data set represents an example historic temporal behavior of the manufacturing installation over a plurality of actual production runs that were carried out and recorded in the past.

In some preferred example embodiments, the first plurality of data pairs may have been recorded “offline”, i.e. well before the upcoming production of a new workpiece in accordance with the new method and installation. By way of example, the data set may comprise a plurality of data pairs recorded during production runs that took place at least one week or month before the new workpiece is produced in accordance with the new method and manufacturing installation. Accordingly, there might be a substantial time gap between the date of recording the latest data pair of the data set and the current instance of time when a new workpiece is produced. A plurality of further workpieces may have been produced during this time gap without an update of the historic data set in some example embodiments.

In contrast, the second plurality of data pairs represent a temporal sequence of recent or even most recent production runs, which means that the second plurality of data pairs represent production runs that precede the current workpiece production run in close temporal proximity, in particular with a time gap of less than one week, preferably less than one day, and further preferably less than 1 hour. The second plurality of data pairs are thus recorded “online” with respect to the current production run.

The current (next or upcoming) production run may therefore be seen as a continuation of the series of most recent production runs. In preferred example embodiments, the current production run is a direct continuation of the series of most recent production runs represented by the second plurality of data pairs, such that the new workpiece is the “next” workpiece of the series. In other example embodiments, however, a limited number of workpieces may have been produced between the last workpiece of the series, as represented by the last data pair of the second plurality of data pairs, and the next workpiece. By way of example, a limited number of workpieces may have been produced but not measured, such that no further most recent measurement values are available to form another data pair of the second plurality of data pairs. Advantageously, the limited number of non-measured workpieces is selected based on how stable the production process appears. For a production process that outputs a plurality of workpieces with very few variations in the workpiece characteristics, the limited number may be chosen higher than for a production process that outputs a plurality of workpieces with higher variations.

In any case, the time gap between the latest data pair of the second plurality of data pairs and the current production run is shorter than any time period over which defined production process fluctuations that affect product quality typically occur. In contrast, the time gap between the latest data pair of the first plurality of data pairs and the current production run is typically longer than such time period. In addition, the number of data pairs of the first plurality of data pairs is preferably higher than the number of data pairs of the second plurality of data pairs. The data set therefore represents a longer history of the installation behavior than the more recent second plurality of data pairs, when the manufacturing installation is in steady operation. In some preferred embodiments, the length T of the temporal sequence of past production runs, i.e. the number of data pairs of the first plurality of data pairs, is

T≥(m+1)L−1,

i.e. T is at least (m+1)L−1, with L being the length of the temporal sequence of recent production runs, i.e. the number of data pairs of the second plurality of data pairs, and m being the number of inputs to the system, i.e. the number of numerical control parameters that can be modified.

The new method and manufacturing installation make beneficial use of the second plurality of data pairs as a defined starting sequence that is to be extended by at least one new data pair. The at least one new data pair is determined in such a manner that it provides modified control parameters for the upcoming production run or production runs in combination with the desired workpiece characteristics of the workpieces to be produced. Such desired workpiece characteristics are represented by the reference sequence, which defines the desired workpiece characteristics in combination with nominal control parameters and nominal measurement values. The nominal control parameters may be derived from the nominal workpiece characteristics and/or from previous production runs of similar-type workpieces. The nominal measurement values are typically derived from the nominal workpiece characteristics, which may be defined by a CAD data set for instance.

Generally, the reference sequence can be considered as describing the theoretical or intended behavior of the manufacturing installation without taking into account real process fluctuations that usually affect any real production run. In contrast, the data set including the first plurality of data pairs and the second plurality of data pairs each represent real behavior of the machine installation during a plurality of past and previous production runs, respectively.

In the new method and manufacturing installation, the modified numerical control parameters are determined as those numerical control parameters that lead to the desired workpiece characteristics as closely as practically possible, taking into account the real behavior of the manufacturing installation under varying environmental parameters, such as temperature, humidity etc., and further effects including wear and tear or material variations. The modified numerical control parameters are advantageously determined as part of at least one new data pair that extrapolates the starting sequence, taking into account the desired workpiece characteristics represented by the reference sequence, and taking into account the history of the past production runs. The starting sequence that is extrapolated is defined by the sequence of recent production runs, i.e. by the second plurality of data pairs.

In some preferred example embodiments, the modified numerical control parameters are determined as an approximation of the reference sequence with the additional constraint that the extrapolation of the starting sequence, as represented by the second plurality of “real” data pairs, has to conform to the real behavior of the manufacturing installation, as represented by the data set. In one example embodiment, the modified numerical control parameters may be determined by minimizing the expression

$${‖ {w}_{f} - {w}_{r} ‖}_{2}^{2} = {\sum }_{k = 1}^{{T}_{f}} {‖ {w}_{f}^{k} - {w}_{r}^{k} ‖}_{2}^{2}$$

wherein wᵣ designates the reference sequence, w_{f} designates a sequence of future data pairs having length T_{f}, with each future data pair including modified numerical control parameters for the next T_{f}, production runs. The sequence w_{f} is a continuation of the starting sequence wᵢₙᵢ of the second plurality of data pairs in such a manner that the concatenated sequences wᵢₙᵢ+w_{f} can be derived as a linear combination of the first plurality of data pairs.

The new method and manufacturing installation are thus based on the assumption that the manufacturing installation can largely be modelled as a linear and time-invariant (LTI) system. Conventionally, such LTI systems are modelled using state-space approaches and/or using Laplace transformations and what is called transfer functions. However, such approaches require extensive advance effort for determining the system model. The new approach allows to proceed without model building just by exploiting the data collected over the plurality of past (historical) production runs represented by the above-mentioned data set. By extrapolating the second plurality of data pairs under the constraints of the reference sequence on the one hand, and the data set on the other hand, the real behavior of the manufacturing installation over past and recent production runs is exploited in order to find a well suited set of numerical control parameters for the next production run or next production runs. Since no model has to be established, the new method and manufacturing installation can be implemented faster. They are able to quickly react to changing environmental parameters, such as temperature, humidity etc., and to other effects that affect product quality, including wear and tear on the moveable machine element or variations in the materials used. Recent variations are advantageously represented in the second plurality of data pairs acting as a starting sequence that is extrapolated by at least one data pair comprising the modified control parameters for the upcoming production run.

The new method and manufacturing installation therefore implement predictive error correction based on production data that is collected during actual production runs in an efficient manner. The new method and manufacturing installation thus allow producing workpieces with high product quality in a very efficient manner. The above-mentioned object is completely achieved.

In a preferred refinement, the method further comprises the steps of recording actual measurement values on the workpiece, associating the modified numerical control parameters and the actual measurement values to form a most recent data pair, and adding the most recent data pair to the second plurality of data pairs to form an updated temporal sequence of recent production runs.

In this refinement, the data determined and collected in connection with the actual production run is efficiently used to update the available data for the future production runs. Therefore, closed loop control can efficiently be implemented and updated on-the-fly from one production run to the next. The new method and manufacturing installation are therefore capable of immediately reacting to changes and variations in the production environment. Product quality and production efficiency are further increased.

In a further refinement, the first plurality of data pairs comprise a plurality of calibration data pairs recorded during a plurality of selected calibration runs using the manufacturing machine and the moveable machine element, with the calibration data pairs each comprising numerical control parameters individually modified in accordance with a calibration strategy.

In this refinement, the data set representing the history of past production runs is collected by exploring the behavior of the machine installation using deliberate changes in the numerical control parameters. This refinement allows to explore the parameter space in a very efficient manner. In some example embodiments, environmental parameters, such as temperature, humidity or brightness may be deliberately change within the plurality of calibration production runs in addition to changing numerical control parameters in order to even more explore the behavior of the manufacturing installation.

In a further refinement, the calibration strategy comprises deliberately randomly changing the numerical control parameters from one calibration production run to another calibration production run of the plurality of calibration runs. Deliberately changing may encompass randomly changing the numerical control parameters from one calibration production run to another calibration production.

This refinement even more helps to efficiently explore the behavior of the manufacturing installation. Randomly changing the control parameters particularly includes pseudo-random changes, as can be derived from mathematical algorithms. Such changes in the control parameters increase the chances to examine the system behavior in a very efficient manner.

In a further refinement, a plurality of calibration workpieces are produced by the plurality of calibration runs, with the plurality of calibration workpieces each forming individual specimens of a same type of workpiece.

In this refinement, the plurality of calibration workpieces each are of the same type, but the numerical control parameters are deliberately changed from one production run to another. The refinement facilitates recording and processing of the production data and, therefore, contributes to an even further improvement of production efficiency. In some example embodiments, the calibration workpieces are of the same type of workpiece as the new workpiece to be produced. In other example embodiments, the calibration workpieces are of a generic type and the data set is used for producing a variety of workpieces of different types and/or sizes.

In a further refinement, the step of defining the reference sequence of data pairs comprises determining a plurality of reference data pairs each comprising the nominal numerical control parameters and the nominal measurement values.

In this refinement, the reference sequence comprises not only one, but a plurality of reference data pairs that advantageously may be the same from one reference data pair to another. The refinement can easily be implemented and nevertheless provides appropriate forward error correction by extrapolating the starting sequence with a plurality of intended “ideal” data pairs.

In a further refinement, determining the modified numerical control parameters comprises determining a plurality of modified numerical control parameters in a sequential order having a start, and wherein modified numerical control parameters from the start of the sequential order are selected for producing the workpiece.

In this refinement, a plurality of data pairs are determined as a sequential concatenation of the initial starting sequence, but only the first data pair of the plurality of data pairs is actually used for producing a workpiece. The remaining data pairs may be discarded. Instead of using the remaining data pairs for actual workpiece production, the modified numerical control parameters from the first data pair and measurement values on the workpiece resulting therefrom after actual workpiece production are associated to form a new most recent data pair that may be added to the second plurality of data pairs. The refinement provides an improved forward error correction for both slowly varying, long-term changes and fast-varying, short-term changes in the production environment.

In a further refinement, the first temporal sequence of the past production runs is subdivided into a plurality of past temporal subsequences using a sliding window procedure, wherein the plurality of past temporal subsequences from the data set are arranged in a Hankel matrix, and wherein the modified numerical control parameters are determined in such a manner that data pairs comprising the modified numerical control parameters are comprised by an image of the Hankel matrix.

This refinement allows for a very efficient determination of the modified numerical control parameters. The refinement can be implemented on almost any conventional computer hardware using well-known quadratic solvers.

In a further refinement, the Hankel matrix is approximated using a low rank approximation computed from a singular value decomposition of the Hankel matrix.

This refinement is particularly advantageous, because it reduces negative effects of noise in the data set of the first plurality of data pairs. Accordingly, product quality of the workpieces produced under varying real world conditions is further increased.

In a further refinement, the first plurality of data pairs is updated at defined time intervals using the modified numerical control parameters.

In this refinement, the data set including the first plurality of data pairs is updated from time to time. The defined time intervals for such an update are much longer than any updates to the second plurality of data pairs. The refinement advantageously increased production error compensation resulting from long-term changes in the manufacturing installation.

It goes without saying that the aforementioned features and those yet to be explained below can be used not only in the combination specified in each case but also in other combinations or on their own, without departing from the scope of the present invention.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 shows a schematic illustration of an example embodiment of the novel manufacturing installation,

FIG. 2 shows a flowchart illustrating an example embodiment of a method for exploring an actual behavior of a manufacturing installation, and

FIG. 3 shows a flowchart illustrating an example embodiment of the new method.

In the drawings, reference numbers may be reused to identify similar and/or identical elements.

### DETAILED DESCRIPTION

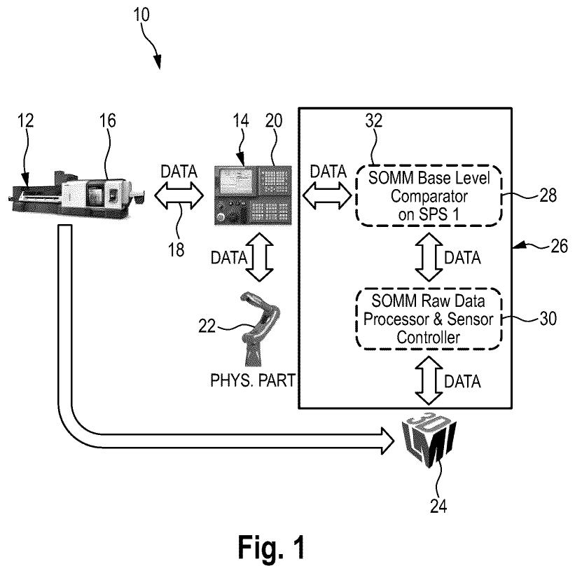

FIG. 1 shows an example embodiment of the new manufacturing installation 10 in a schematic illustration. Manufacturing installation 10 comprises a manufacturing machine 12 that is controlled by an associated machine controller 14. Manufacturing machine 12 is shown here as a multi-axis machine tool that is capable of at least one of cutting, milling, drilling, turning and/or grinding a workpiece. Suitable machine tools are commercially available from a plurality of vendors such as DMG Mori Seiki, Chiron, Heller and many others. Additionally, or alternatively, manufacturing machine 12 may be a machine that is capable of welding, bending, pressing, additively and/or chemically manufacturing a workpiece. Without limitation, any type and brand of a controller-controlled manufacturing machine that is capable of producing a workpiece from a raw material based on a CAD data set could be used here. All these manufacturing machines have at least one moveable machine element 16 controlled by machine controller 14, as is readily known to those skilled in the art. The at least one moveable machine element 16 may be a tool head that carries a cutting tool, milling tool, drilling tool, turning tool, grinding tool, welding tool, bending tool, pressing tool and/or a laser processing tool. Moreover, the moveable machine element 16 may be or may comprise an operating valve in a manufacturing installation that processes fluids and controls chemical reactions via a moveable machine element in the valve, for instance.

Manufacturing machine 12 and machine controller 14 exchange control data 18. The control data include, in particular, control commands and numerical control parameters, as is known to those skilled in the art. By way of example, the control program may conform to what is known G-code or M-code and a numerical control parameter may define the rotational speed of a tool head or a distance of travel of the tool head, while the control command may activate a motor driving the moveable machine element.

The control commands are typically determined based on a data set defining desired workpiece characteristics, such as a CAD data set indicated at reference numeral 20 in FIG. 1. A workpiece (not shown here) is produced during a production run using the control data 18 in a manner known per se to those skilled in the art.

When the production run is finished, the workpiece is removed from the manufacturing machine 12, preferably by an automated handling system 22, such as a robot, and conveyed for further processing, such as being stacked in pallets. Preferably, automated removal is synchronized with manufacturing machine controller 14. In some example embodiments, controller 14 may therefore exchange further control data with handling system 22 or even control handling system 22.

In some example embodiments, handling system 22 automatically transfers the workpiece produced in the production run to a metrology device 24. Metrology device 24 may be a coordinate measuring machine (CMM) using a contact-type and/or non-contact-type probe, a computed tomography device, an industrial microscope and/or any other metrology device suitable and configured for inspecting the workpiece with respect to its workpiece characteristics. Optical metrology with cameras and/or laser scanners is particularly attractive in the field of machining, additive manufacturing (3D printing) and other forming processes. However, measurement technology and inspection are not limited to dimensional measurement technologies. Other defect detection methods are also conceivable, such as deflectometry, eddy current analysis, surface roughness profilometers, acoustic measurements, etc.

Metrology device 24 is preferably located in the vicinity of manufacturing machine 12 and preferably configured to automatically inspect the workpiece using a predefined inspection plan. In some example embodiments, metrology device 24 may be configured to automatically measure 3D point cloud data of measurement points recorded on the workpiece in order to determine dimensional and/or geometrical characteristics of the workpiece in accordance with the predefined inspection plan. The inspection plan may also be determined based on the CAD data set 18. In some example embodiments, metrology device 24 may be a probing head integrated into manufacturing machine 12, or a probing head that can selectively be introduced into manufacturing machine 12, in order to record measurement values on the workpiece while it is still fixed in the manufacturing machine 12. In yet another example embodiment, metrology device 24 may be a hand-held device, such as a hand-held 3D laser scanner.

In any case, metrology device 24 is a physical inspection device capable of and configured for recording measurement/inspection values on the workpiece, which measurement/inspection values represent actual workpiece characteristics. Preferably, automated test sequences and algorithmic interpretation of the results are implemented, such as DIN-ISO-compliant point cloud evaluation, CAD rule geometry comparisons, form and position evaluations, etc. In some preferred example embodiments, software tools commercially available from Carl Zeiss Industrielle Messtechnik GmbH, Germany, are used, such as the software tools Calypso (for regular geometries), Caligo (for free-form surfaces), Gear Pro (especially for measuring gears), GOM Inspect and/or GOM Volume Inspect.

In FIG. 1, manufacturing installation 10 further comprises a correction controller 26 that is configured to carry out at least one of the method steps explained further down below. In preferred example embodiments, correction controller 26 is implemented as one or more software components comprising executable software code that is executed on one or more hardware processors in a manner readily known to those skilled in the art. The one or more hardware processors may be commercially available microprocessors from Intel, AMD, Apple, IBM, Fairchild, ARM or others. In some example embodiments, the software components implementing the correction controller 26 may be installed and/or executed on commercially available computer hardware operating one or more of commercially available computer hardware operating systems, such as Windows, Linux, MacOS. In some example embodiments, the software components implementing the correction controller 26 may be installed and/or executed on one or more virtual machines, such as virtual machines based on Hyper-V, Powershell and/or Kybernetes Clusters. The software components implementing the correction controller 26 may be installed on hardware already present in a conventional manufacturing installation, such as the hardware implementing machine controller 14. By way of example, there are programmable logic controllers (PLCs) acting as machine controllers and implemented on hardware that is similar to hardware of a conventional personal computer running an operating system like Windows or Unix/Linux. The functionality of the correction controller 26 may also be implemented on such a hardware platform. In yet further example embodiments, the software components implementing the functionality of the correction controller 26 may be installed on cloud computers and/or edge computers of a computer network.

Correction controller 26 may include a user interface (not shown here) for allowing user interaction, such as a computer display, a keyboard, a mouse, a trackball etc. In FIG. 1, the example embodiment further comprises a functional module 28 that is called SOMM base level comparator in the following and is implemented as a software module that facilitates at least one of the following method steps:
obtaining nominal workpiece data defining desired workpiece characteristics for the workpiece,
obtaining a control program comprising a plurality of control commands and a plurality of nominal numerical control parameters, with the nominal numerical control parameters each determining a nominal kinematic behavior of the moveable machine element during a production run,
obtaining a data set that comprises a plurality of past numerical control parameters used during a plurality of past production runs on manufacturing machine 12 and comprises a plurality of past measurement values recorded on workpieces produced by the plurality of past production runs, wherein the plurality of past numerical control parameters and the plurality of past measurement values form a first plurality of data pairs representing a first temporal sequence of the past production runs; the data set may comprise the first plurality of data pairs arranged in a Hankel matrix having a defined rank,
obtaining a second plurality of data pairs that represent a temporal sequence of recent production runs on manufacturing machine 12, with each data pair of the second plurality of data pairs comprising respective actual numerical control parameters used during a respective one of the recent production runs and respective actual measurement values resulting therefrom,
obtaining a reference sequence of data pairs based on the nominal numerical control parameters and based on nominal measurement values corresponding to the nominal workpiece data,
determining modified numerical control parameters using the reference sequence of data pairs, using the data set comprising the first plurality of data pairs, and using the second plurality of data pairs as a defined starting sequence, wherein the modified numerical control parameters define at least one data pair that extends the defined starting sequence based on the first plurality of data pairs and based on the reference sequence of data pairs, and
transferring the modified numerical control parameters to machine controller 14 for a next production run.

By way of example, a cutting tool may be moved a small amount further into the workpiece during machining compared to what would have been the case if the nominal numerical control parameters were use in order to compensate for increasing wear of the cutting tool over a plurality of production runs.

In the example embodiment shown, correction controller 26 optionally comprises a functional module 30 SOMM raw data processor & sensor controller in FIG. 1. Software module 30 operates as a metrology sensor adapter configured to generate formatted point cloud data in a predefined format from raw measurement values obtained by metrology device 24. The formatted point cloud data preferably represent the produced workpiece by a plurality of 3D points relative to a predefined coordinate system in a standardized form, such that various types and brands of metrology devices 24 may be used to communicate with SOMM base level comparator 28. Functional modules 28, 30 may exchange data with each other and with machine controller 14 or metrology device 24, respectively, as indicated in FIG. 1. Preferably, correction controller 26 further comprises a dedicated machine adapter configured to translate error correction commands into the plurality of modified control commands and parameters for a specific type and brand of machine controller 14 used in the respective manufacturing installation.

With respect to further details and variations of such a manufacturing installation, reference is made to applicants co-pending international patent application PCT/EP2023/068020, filed on 30 Jun. 2023 with the European Patent Office, which co-pending international patent application is incorporated by reference herewith in its entirety. As described above, one or more method steps of the new method may be implemented on the SOMM base level comparator described in more detail in PCT/EP2023/068020. In addition or alternatively, one or more method steps of the new method may be implemented on what is termed SOMM High Level Controller in PCT/EP2023/068020. By way of example, a data set comprising a first plurality of data pairs may be recorded on one manufacturing machine and later obtained on another manufacturing machine via the SOMM High Level Controller.

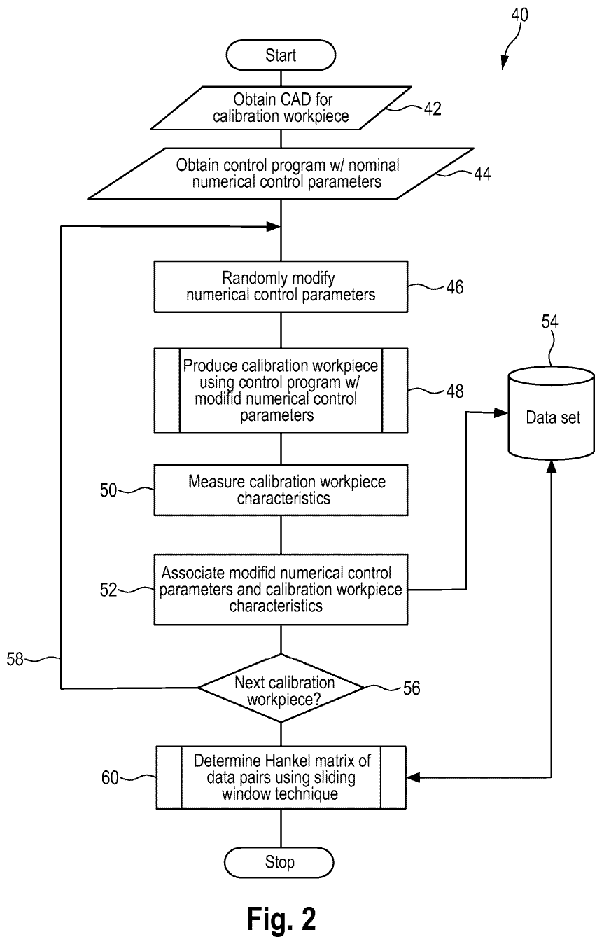

FIG. 2 shows an example embodiment of a preferred method 40 for exploring the behavior of the manufacturing installation 10 in order to form a data set that can later be used for efficiently producing high quality workpieces with the manufacturing installation 10. In other words, method 40 is an example embodiment for recording an actual production history of manufacturing installation 10.

According to step 42, nominal workpiece characteristics for a calibration workpiece (not shown here) are obtained. The nominal workpiece characteristics may be defined in a CAD data file. Based on the nominal workpiece characteristics, and as shown at reference numeral 44, a control program comprising control commands and nominal numerical control parameters is determined in a manner known to those skilled in the art. At step 46, however, one or more nominal numerical control parameters are randomly changed. Preferably, the respective changes are limited such that predefined thresholds are not exceeded. This helps to keep the manufacturing installation within its usual operating limits. By way of example, one or more nominal numerical control parameters may randomly be changed within limits of up to 20%, preferably up to 10% with respect to the respective nominal numerical control parameter.

At step 48, a calibration workpiece is produced using the manufacturing installation 10 and the control program with the modified numerical control parameters. According to step 50, the calibration workpiece is measured in order to determine actual workpiece characteristics of the calibration workpiece. According to step 52, the modified numerical control parameters and the workpiece characteristics of the calibration workpiece resulting therefrom are associated. In some preferred example embodiments, the modified numerical control parameters and the associated workpiece characteristics form a data pair wₖ=(uₖ, yₖ) comprising an input vector uₖ containing the modified numerical control parameters and an output vector yₖ containing the measurement values representing the workpiece characteristics. The data pair wₖ is stored in data set 54.

At step 56, it is decided if another calibration workpiece is to be produced. If in the affirmative, the method loops back to step 46, as is shown at reference numeral 58 and another calibration workpiece is produced with another set of randomly modified control parameters. If a predefined number T of calibration workpieces is produced, the data pairs wₖ preferably are arranged in a sequence according to the temporal order of the calibration workpieces produced, such that a temporal sequence w_{d}=(w₁, w₂, w₃ . . . , w_{T}) of the calibration production runs is established.

According to step 60, a sliding window technique may be used to split the temporal sequence w_{d}=(w₁, w₂, w₃ . . . , w_{T}) into a plurality of subsequences of length L<T. The subsequences may advantageously be arranged in a Hankel matrix H_{L}(w_{d}) as follows

$${H}_{L} ( {w}_{d} ) = [ \begin{matrix}{w}_{1} & … & {w}_{T - L + 1} \\ ⋮ & ⋱ & ⋮ \\ {w}_{L} & … & {w}_{T}\end{matrix} ]$$

and also stored in data set 54. As a result, data set 54 comprises a plurality of past numerical control parameters uₖ used during a plurality of past production runs on manufacturing machine 12, and comprises a plurality of past measurement values yₖ recorded on (calibration) workpieces produced by the plurality of past production runs. The plurality of past numerical control parameters and the plurality of past measurement values are associated to each other such that a first plurality of data pairs wₖ=(uₖ, yₖ) are formed, with each data pair wₖ comprising past numerical control parameters uₖ and past measurement values yₖ resulting therefrom. The first plurality of data pairs wₖ thus represent a temporal sequence w_{d} of the past production runs.

The predefined number T is preferably selected such that the Hankel matrix H_{L}(w_{d}) reaches its maximal theoretical rank which can be proven to be

rank H_{L}(w_{d})=mL+n

with n representing an estimated upper bound of the number of hidden states of the system, i.e. manufacturing installation 10. Any sequence w of data pairs that is part of the image of Hankel matrix H_{L}(w_{d}) is a “valid” sequence that can be achieved with manufacturing installation 10. Verification can be performed by the condition

rank[H_{L}(w_{d})w]=rank H_{L}(w_{d})

In general, one can say that any valid sequence w represents a trajectory in a parameter space that is spanned by the temporal sequence w_{d}=(w₁, w₂, w₃ . . . , w_{T}) of the first plurality of data pairs wₖ. This is advantageously used in the following to determine modified numerical control parameters for a new production run on manufacturing installation 10.

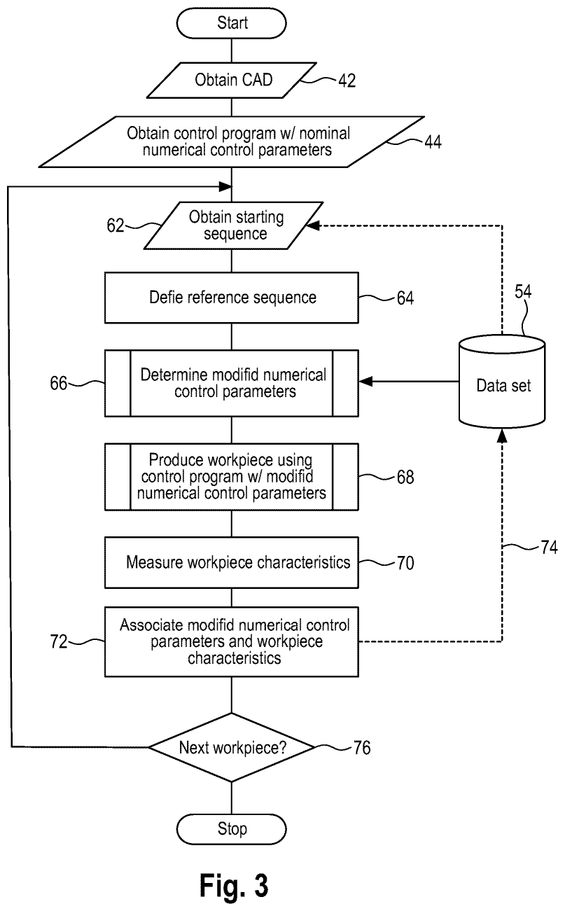

As shown in FIG. 3 at step 42, the desired workpiece characteristics for a next workpiece to be produced are obtained. As in the method shown in FIG. 2, desired workpiece characteristics may be represented in a CAD data set or in any other data set equivalent thereto. According to step 44, a control program comprising control commands and nominal numerical control parameters is determined based on the desired workpiece characteristics. Steps 42 and 44 equal steps 42, 44 in the method shown with reference to FIG. 2 and, therefore, same reference numerals have been used.

At step 62, a starting sequence wᵢₙᵢ of data pairs representing more recent production runs on manufacturing installation 10 is obtained. The starting sequence wᵢₙᵢ has a predefined length Tᵢₙᵢ, i.e. it comprises a predefined number Tᵢₙᵢ of data pairs. A prediction horizon T_{f} is selected. The Hankel matrix H_{L}(w_{d}) has a maximal rank for L=Tᵢₙᵢ+T_{f}.

In some example embodiments, one or more data pairs for the starting sequence wᵢₙᵢ may be taken from the first plurality of data pairs in data set 54. Therefore, one or more data pairs of starting sequence wᵢₙᵢ may originate from the calibration runs, if the next workpiece is among the first workpieces to be produced after the calibration runs. With ongoing use of manufacturing installation 10, however, the data pairs of starting sequence wᵢₙᵢ will differ from the data pairs of the calibration runs, which is expressed here be differentiating between past production runs used to form data set 54 and recent production runs used to form starting sequence wᵢₙᵢ.

At step 64, a reference sequence wᵣ=(uᵣ, yᵣ) of data pairs is determined from the desired workpiece characteristics and, by way of example, from the nominal numerical control parameters. Alternatively, numerical control parameters already modified for previous production runs may be used, which is particularly advantageous if a series of workpieces of the same type and size is produced in successive production runs. In some example embodiments, reference sequence wᵣ may have a plurality of data pairs (uᵣ, yᵣ) that each are the same. The length of reference sequence wᵣ is preferably chosen to be the same as prediction horizon T_{f}. In any case, reference sequence wᵣ does not need to be a valid trajectory within the parameter space of manufacturing installation 10. Rather, it is a theoretical sequence of set values.

According to step 66, modified numerical control parameters are now determined by searching for a future sequence w_{f}=(u_{f}, y_{f}) of data pairs that minimizes the expression

$${‖ {w}_{f} - {w}_{r} ‖}_{2}^{2} = {\sum }_{k = 1}^{{T}_{f}} {‖ {w}_{f}^{k} - {w}_{r}^{k} ‖}_{2}^{2}$$

and, additionally, is a valid continuation of starting sequence wᵢₙᵢ. The concatenation of sequence wᵢₙᵢ and sequence w_{f} has to form a valid sequence of length L=Tᵢₙᵢ+T_{f}. In this regard, one can say that concatenated sequences wᵢₙᵢ and w_{f} substantially can be derived as a linear combination of the sequences of data set 54. The optimization task can be solved by standard methods and quadratic solvers, such as https://osqp.org.

Preferably, the modified numerical control parameters of the first data pair of the sequence T_{f} are used for the next production run in accordance with step 68. According to step 70, the workpiece produced in step 68 using the modified numerical control parameters is measured to determine its actual workpiece characteristics. According to step 72, the modified numerical control parameters and the actual workpiece characteristics are associated to form a most recent data pair that is advantageously used to update the starting sequence wᵢₙᵢ for the next production run, as it is indicated at reference numeral 74. However, it is conceivable to skip step 70 for a limited number of workpieces in a series production, if production cycle times are considerably shorter than process fluctuations. Accordingly, yet another workpiece may be produced in accordance with step 76.

The method according to FIG. 3 is based on the assumption that manufacturing installation 10 is a linear and time-invariant system and that the data is exact, i.e. not subject to noise. In case of unacceptably noisy data, there are several tools which can preferably be applied to overcome the issue. A simple one is to approximate the Hankel matrix using a low rank approximation computed from a singular value decomposition of H_{L}(w_{d}).

Another approach is to leave the Hankel matrix H_{L}(w_{d}) unaltered and to modify the optimization problem instead. These modifications target both noise in the initial data and in the representation data and comprise adding relaxation terms to the objective function and constraint relaxation by introducing penalized slack variables, as is suggested by Ivan Markovsky and Florian Dörfler in the publication “Behavioral systems theory in data-driven analysis, signal processing, and control” mentioned at the outset. Moreover, it has turned out that the method according to FIG. 3 also performs well for non-linear systems. In some example embodiments, the data set 54 may be updated from time to time in order to compensate for time variant behavior or non-linearities.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD or DVD). The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR. The phrase “A, B, and/or C” should be construed in the same way as the phrase “at least one of A, B, and C.”

1. A method for producing a workpiece using a manufacturing installation including a manufacturing machine having a moveable machine element, a machine controller configured to control the moveable machine element based on a control program, and a metrology device configured to record a set of measurement values on the workpiece in order to determine workpiece characteristics of the workpiece, the method comprising:
obtaining nominal workpiece data defining desired workpiece characteristics for the workpiece;
obtaining the control program, the control program including a plurality of control commands and a plurality of nominal numerical control parameters, with the plurality of nominal numerical control parameters each determining a respective nominal kinematic behavior of the moveable machine element during a production run;
obtaining a data set that includes:
a plurality of past numerical control parameters used during a plurality of past production runs on the manufacturing machine, and
a plurality of past measurement values recorded on workpieces produced by the plurality of past production runs,
wherein the plurality of past numerical control parameters and the plurality of past measurement values are associated with each other based on the workpieces produced such that a first plurality of data pairs are formed, with each data pair of the first plurality of data pairs including past numerical control parameters and past measurement values resulting therefrom, and with the first plurality of data pairs representing a first temporal sequence of the plurality of past production runs;
obtaining a second plurality of data pairs that represent a temporal sequence of recent production runs, with each data pair of the second plurality of data pairs including respective actual numerical control parameters used during a respective one of the recent production runs and respective actual measurement values resulting therefrom;
defining a reference sequence of data pairs based on the plurality of nominal numerical control parameters and based on nominal measurement values corresponding to the nominal workpiece data;
determining modified numerical control parameters using (i) the reference sequence of data pairs, (ii) the data set including the first plurality of data pairs, and (iii) the second plurality of data pairs, wherein:
the second plurality of data pairs are used as a starting sequence; and
the modified numerical control parameters define at least one data pair that extends the starting sequence based on the first plurality of data pairs and based on the nominal measurement values from the reference sequence of data pairs; and
producing the workpiece using the moveable machine element, the machine controller and the control program in combination with the modified numerical control parameters instead of the plurality of nominal numerical control parameters.

2. The method of claim 1, further comprising:
recording actual measurement values on the workpiece,
associating the modified numerical control parameters and the actual measurement values to form a most recent data pair, and
adding the most recent data pair to the second plurality of data pairs to form an updated temporal sequence of recent production runs.

3. The method of claim 1, wherein the first plurality of data pairs includes a plurality of calibration data pairs recorded during a plurality of selected calibration runs using the manufacturing machine, with the plurality of calibration data pairs each including numerical control parameters individually modified in accordance with a calibration strategy.

4. The method of claim 3, wherein the calibration strategy includes changing the numerical control parameters from one calibration production run to another calibration production run of the plurality of selected calibration runs in a predefined manner.

5. The method of claim 4, wherein the predefined manner includes randomly changing the numerical control parameters from one calibration production run to another calibration production run of the plurality of selected calibration runs.

6. The method of claim 5, wherein a plurality of calibration workpieces are produced by the plurality of selected calibration runs, with the plurality of calibration workpieces each forming individual specimens of a same type of workpiece.

7. The method of claim 1, wherein defining the reference sequence of data pairs includes determining a plurality of reference data pairs each including the plurality of nominal numerical control parameters and the nominal measurement values.

8. The method of claim 7, wherein determining the modified numerical control parameters includes determining a plurality of modified numerical control parameters in a sequential order having a start, and wherein modified numerical control parameters from the start of the sequential order are selected for producing the workpiece.

9. The method of claim 8, wherein the first temporal sequence of the plurality of past production runs is subdivided into a plurality of past temporal subsequences using a sliding window procedure, wherein the plurality of past temporal subsequences from the data set are arranged in a Hankel matrix, and wherein the modified numerical control parameters are determined in such a manner that data pairs including the modified numerical control parameters are included by an image of the Hankel matrix.

10. The method of claim 9, wherein the Hankel matrix is approximated using a low rank approximation computed from a singular value decomposition of the Hankel matrix.

11. The method of claim 1, wherein the first plurality of data pairs is updated at defined intervals using the modified numerical control parameters.

12. A device for producing a workpiece, the device comprising:
a manufacturing machine having a moveable machine element;
a machine controller configured to control the moveable machine element based on a control program; and
a metrology device configured to record a set of measurement values on the workpiece in order to determine workpiece characteristics of the workpiece,
wherein the machine controller includes at least one processor configured to:
obtain nominal workpiece data defining desired workpiece characteristics for the workpiece,
obtain the control program, wherein the control program includes a plurality of control commands and a plurality of nominal numerical control parameters, with the plurality of nominal numerical control parameters each determining a respective nominal kinematic behavior of the moveable machine element during a production run,
obtain a data set that includes:
a plurality of past numerical control parameters used during a plurality of past production runs on the manufacturing machine; and
a plurality of past measurement values recorded on workpieces produced by the plurality of past production runs,
wherein the plurality of past numerical control parameters and the plurality of past measurement values are associated to each other based on the workpieces produced such that a first plurality of data pairs are formed, with each data pair of the first plurality of data pairs including past numerical control parameters and past measurement values resulting therefrom, and with the first plurality of data pairs representing a first temporal sequence of the plurality of past production runs,
obtain a second plurality of data pairs that represent a temporal sequence of recent production runs, with each data pair of the second plurality of data pairs including respective actual numerical control parameters used during a respective one of the recent production runs and respective actual measurement values resulting therefrom,
obtain a reference sequence of data pairs based on the plurality of nominal numerical control parameters and based on nominal measurement values corresponding to the nominal workpiece data,
determine modified numerical control parameters using the reference sequence of data pairs, using the data set including the first plurality of data pairs, and using the second plurality of data pairs, wherein:
the second plurality of data pairs define a starting sequence; and
the modified numerical control parameters define at least one data pair that extends the starting sequence based on the first plurality of data pairs and based on the nominal measurement values from the reference sequence of data pairs, and
produce the workpiece using the moveable machine element, the machine controller and the control program in combination with the modified numerical control parameters instead of the plurality of nominal numerical control parameters.

13. A non-transitory computer-readable medium comprising program code that is configured to perform, when the program code is executed on at least one processor of a manufacturing installation that includes a moveable machine element:
obtaining nominal workpiece data defining desired workpiece characteristics for a workpiece;
obtaining a control program, the control program including a plurality of control commands and a plurality of nominal numerical control parameters, with each of the plurality of nominal numerical control parameters determining a respective nominal kinematic behavior of the moveable machine element during a production run;
obtaining a data set that includes:
a plurality of past numerical control parameters used during a plurality of past production runs on a manufacturing machine; and
a plurality of past measurement values recorded on workpieces produced by the plurality of past production runs,
wherein the plurality of past numerical control parameters and the plurality of past measurement values are associated to each other based on the workpieces produced such that a first plurality of data pairs are formed, with each data pair of the first plurality of data pairs including past numerical control parameters and past measurement values resulting therefrom, and with the first plurality of data pairs representing a first temporal sequence of the plurality of past production runs;
obtaining a second plurality of data pairs that represent a temporal sequence of recent production runs, with each data pair of the second plurality of data pairs including respective actual numerical control parameters used during a respective one of the recent production runs and respective actual measurement values resulting therefrom;
obtaining a reference sequence of data pairs based on the plurality of nominal numerical control parameters and based on nominal measurement values corresponding to the nominal workpiece data;
determining modified numerical control parameters using the reference sequence of data pairs, using the data set including the first plurality of data pairs, and using the second plurality of data pairs, wherein:
the second plurality of data pairs define a starting sequence; and
the modified numerical control parameters define at least one data pair that extends the starting sequence based on the first plurality of data pairs and based on the nominal measurement values from the reference sequence of data pairs; and
controlling the moveable machine element using the control program in combination with the modified numerical control parameters instead of the plurality of nominal numerical control parameters.
